(19) United States
(12) Patent Application Publication
(10) Pub. No.: US 2007/0092713 A1
(43) Pub. Date: Apr. 26, 2007

(54) Composite sandwich structure and process using TPO thermoplastic skins

(75) Inventors: Paul Arthur Trudeau, Caledon (CA); Lassi M. Ojanen, Richmond Hill (CA)

Correspondence Address: WARN, HOFFMANN, MILLER & LALONE, .P.C, PO BOX 70098, ROCHESTER HILLS, MI, 48307, US

(73) Assignee: Magna International Inc., Aurora (CA)

(21) Appl. No.: 11/259,652

(22) Filed: Oct. 26, 2005

(51) Int. Cl. B32B 3/26; B32B 9/00; B32B 7/12; B32B 15/04

(52) U.S. Cl. 428/304.4; 428/318.4; 428/343; 428/354

(57) ABSTRACT

A composite sandwich structure is provided. The composite includes a first thermoplastic layer, such as a thermoplastic polyolefin, having an inner surface and an outer surface, wherein the inner surface of the first thermoplastic layer does not include a UV stabilizer. A second thermoplastic layer, such as a thermoplastic polyolefin, is spaced and opposed from the first thermoplastic layer, and includes an inner surface and an outer surface, wherein the inner surface of the second thermoplastic layer does not include a UV stabilizer. First and second UV-curable tie layers are disposed on the inner surfaces of the first and second thermoplastic layers. First and second UV-curable adhesive layers are disposed on the first and second tie layers. First and second reinforcement layers, such as fiberglass, are disposed on the first and second adhesive layers. A foam layer, such as polyurethane foam, is disposed between the first and second tie layers.

### FIELD OF THE INVENTION

The present invention relates generally to composite structures, and more particularly to fiber-reinforced composite sandwich structures including a UV-curable tie layer that readily bonds to a thermoplastic polyolefin skin, a UV-curable adhesive layer disposed on the tie layer, and/or a polyurethane foam core disposed on the tie layer.

### BACKGROUND OF THE INVENTION

Conventional composite sandwich structures, such as those used in automotive applications, typically employ polycarbonate (PC)/acryl-butyl-styrene (ABS) thermoplastic skins on the outer surfaces of the structure. An underlying polyurethane foam readily bonds to the inner surface of the thermoplastic skin thus creating adhesion therebetween. Co-extruded acryl styrene acrylester (ASA)/PC over the PC/ABS layer has been used to impart UV stability. An example of a fiber-reinforced composite structure can be found in U.S. Pat. No. 6,331,028 to O'Neill et al, the entire specification of which is expressly incorporated herein by reference. However, the resulting thermoplastic skins of these conventional composite sandwich structures still weathered poorly and had poor resistance to solvents, contrary to the attributes that are typically required by the original equipment manufacturer's customers.

Accordingly, there exists a need for new and improved composite sandwich structures that include components that are readily bonded together and which exhibit enhanced physical and/or mechanical properties.

### SUMMARY OF THE INVENTION

It is an object of the present invention to provide new and improved composite sandwich structures.

It is another object of the present invention to provide new and improved composite sandwich structures that include components that are readily bonded together and which exhibit enhanced physical and/or mechanical properties.

It is still another object of the present invention to provide new and improved composite sandwich structures that include components that are readily bonded together and which exhibit enhanced physical and/or mechanical properties, wherein a tie layer is provided between a TPO skin layer and a polyurethane foam layer, wherein the surface of the TPO skin layer facing the tie layer and the polyurethane foam layer is free of UV stabilizers.

In accordance with a first embodiment of the present invention, a composite sandwich structure is provided, comprising: (1) a thermoplastic layer having an inner surface and an outer surface, wherein the inner surface does not include a UV stabilizer; and (2) a tie layer disposed on the inner surface of the thermoplastic layer.

In accordance with a second embodiment of the present invention, a composite sandwich structure is provided, comprising: (1) a first thermoplastic layer having an inner surface and an outer surface, wherein the inner surface of the first thermoplastic layer does not include a UV stabilizer; (2) a first tie layer disposed on the inner surface of the first thermoplastic layer; (3) a second thermoplastic layer having an inner surface and an outer surface, wherein the inner surface of the second thermoplastic layer does not include a UV stabilizer; and (4) a second tie layer disposed on the inner surface of the second thermoplastic layer.

In accordance with a third embodiment of the present invention, a method for forming a composite sandwich structure is provided, comprising: (1) providing a thermoplastic layer having an inner surface and an outer surface, wherein the inner surface does not include a UV stabilizer; and (2) disposing a UV-curable tie layer on the inner surface of the thermoplastic layer.

### BRIEF DESCRIPTION OF THE DRAWINGS

The present invention will become more fully understood from the detailed description and the accompanying drawings, wherein:

FIG. 1 is a partial sectional view of a composite sandwich structure, in accordance with a first embodiment of the present invention; and

FIG. 2 is a broken-away perspective view of the composite sandwich structure depicted in FIG. 1, in accordance with a first embodiment of the present invention;

FIG. 3 is a partial sectional view of an alternative composite sandwich structure, in accordance with a second embodiment of the present invention; and

FIG. 4 is a broken-away view of the alternative composite sandwich structure depicted in FIG. 3, in accordance with a second embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

The composite sandwich structures of the present invention can be used in a variety of applications, including but not limited to automotive or other types of vehicles, and structural components thereof.

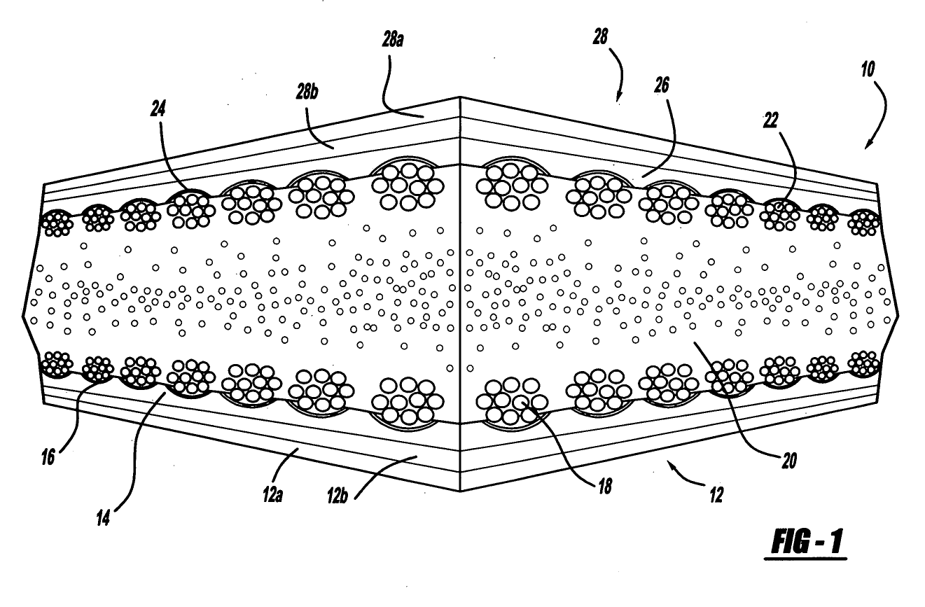

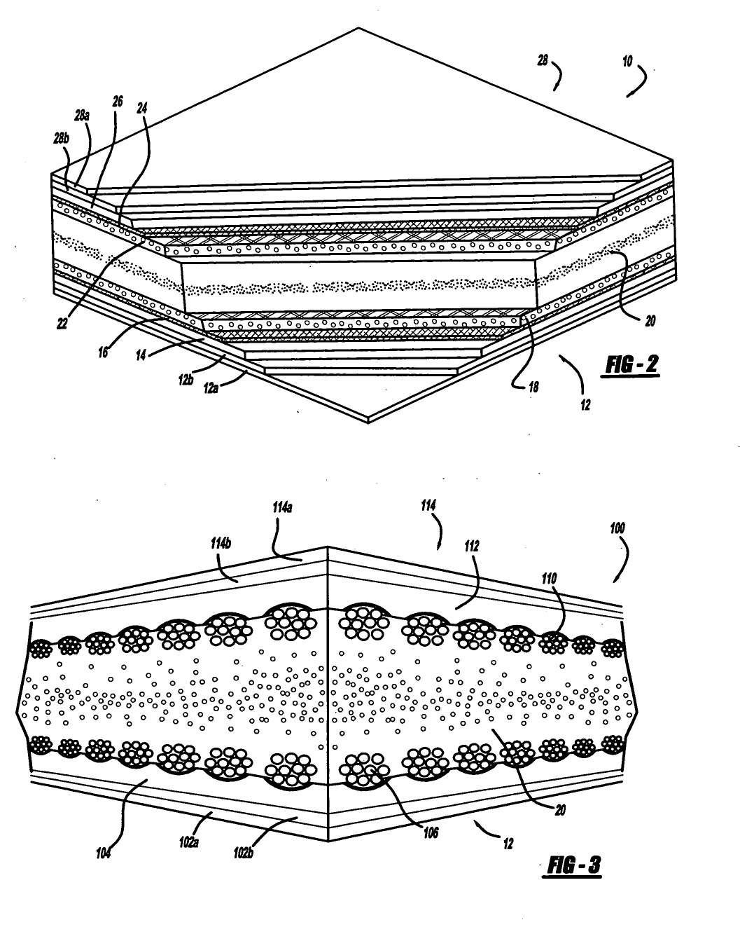

Referring to FIGS. 1 and 2, there is shown a cross-sectional view of a composite sandwich structure, generally shown at 10, in accordance with one embodiment of the present invention. The structure 10 primarily includes a TPO skin layer 12, a tie layer 14, an adhesive layer 16, a reinforcement layer 18, an optional foam layer 20, another optional reinforcement layer 22, another optional adhesive layer 24, another optional tie layer 26, and another optional TPO skin layer 28.

The TPO skin layers 12, 28, respectively, are actually comprised of two sub-layers 12a, 12b, 28a, 28b, respectively. The outermost layers, 12a, 28a, respectively, are comprised of TPO materials that include conventional UV stabilizers so as to provide enhanced weatherability to the structure 10, e.g., when it is exposed to UV sources. However, underlying sub-layers 12b, 28b, respectively, are comprised of TPO materials that do not contain any or any appreciable amounts of UV stabilizers, the reason for which will be explained herein. By way of a non-limiting example, the respective layers 12a, 12b and 28a, 28b, can be co-extruded together to form TPO skin layers 12, 28, respectively.

The type of TPO employed in the present invention is E3000 HMS, which is readily commercially available from Solvay Engineered Polymers (Mansfield, Tex.). This TPO product is available in UV stabilizer form and UV stabilizer free form. As previously noted, it is important that the UV stabilizer was not present on the surface that was intended to be in contact with either the tie layer 14 and/or the foam layer 20, i.e., sub-layers 12b, 28b, respectively.

Without being bound to a particular theory of the operation of the present invention, the color of the sheet may impact the quality of the bond between the tie layers 14, 26, respectively, and sub-layers 12b, 28b, respectively. Without being bound to a particular theory of the operation of the present invention, the most difficult color to work with is believed to be black. In the event black is used for the inner sub-layer of the TPO skin layer, certain photo-initiators can be used in the tie layer which requires less energy to cure. Testing on parts having TPO formulations that included carbon black exhibited lower adhesion characteristics over parts using grey colored TPO. Without being bound to a particular theory of the operation of the present invention, the difference in adhesion performance is believed to be due to the color difference, not due to the carbon content.

Other types of TPO would work as well in the practice of the present invention. For example, the E-3000 brand was selected because certain automotive manufacturers use a similar grade on various production programs. Regardless of the particular type or brand of TPO used, the key consideration remains that UV stabilizers can not be present on the bonding (i.e., inner) surface of the TPO, i.e., sub-layers 12b, 28b, respectively.

The tie layer 14 is a sprayable UV-curable material that is applied to the entire, or substantially the entire, surface of sub-layers 12b, 28b, respectively. Because the tie layer 14 is UV-curable, the presence of UV stabilizers in sub-layers 12b, 28b, respectively, could potentially interfere with the curing process, as well as cause poor adhesion between sub-layers 12b, 28b, respectively, and tie layers 14, 26, respectively. The tie layer chemistry, to be described herein, is formulated so as to bond aggressively to sub-layers 12b, 28b, respectively, with available hydroxyl groups to aid in the chemical linkage to the foam layer 20.

In accordance with one aspect of the present invention, the tie layers 14, 26, respectively, are comprised of UV-curable materials. By way of a non-limiting example, the tie layers 14, 26, respectively, are comprised of a blend of acrylic monomers, initiators and oligomers. The monomers can include, without limitation, blends of methyl methacrylate, N,N-dimethylacrylamide (NNDMA), isobornyl acrylate (IBOA). Various photo-initiators can be used, such as but not limited to various IRGACURE brand photo-initiators readily commercially available from Ciba Specialty Chemicals, Inc. (Basel, Switzerland).

It should be appreciated that other tie layer formulations with different monomers, oligomers and photo initiators, can be used in the practice of the present invention. Additionally, silanes can be employed to improve adhesion to the reinforcement structures 18, 22, respectively, especially those comprised of fiberglass materials.

A typical formulation of the tie layer component of the present invention is presented in Table I, set forth below:

TABLE I

| Component | Weight Percent |
|---|---|
| Isobornyl Acrylate (Ciba Specialty | 30-40 |
| Chemicals, Basel, Switzerland) which, | |
| without being bound to a particular theory | |
| of the operation of the present invention, | |
| increases hardness, lowers shrinkage and | |
| provided high Tg | |
| Aliphatic Urethane Acrylate (e.g., BR-3641 | 10-30 |
| AA (Bomar Specialties Chemicals, | |
| Winsted, Connecticut)) which, without | |
| being bound to a particular theory of the | |
| operation of the present invention, | |
| promotes adhesion and provides a | |
| reactive tackifier | |
| NNDMA | 20-30 |
| Methyl methacrylate | 0-15 |
| IRGACURE 907 (Ciba Specialty | 0-2 |
| Chemicals, Basel, Switzerland) which, | |
| without being bound to a particular theory | |
| of the operation of the present invention, | |
| provides strong light absorption | |
| characteristics | |
| IRGACURE 184/TPO (1/1) (Ciba Specialty | 0-2 |
| Chemicals, Basel, Switzerland) which, | |
| without being bound to a particular theory | |
| of the operation of the present invention, | |
| provides a highly efficient photoinitiator | |
| with unsaturated pre-polymers in | |
| combination with vinyl monomers | |

The adhesion between sub-layers 12b, 28b, respectively, and the foam layer 20 is achieved by tie layers 14, 26, respectively, that readily bonds, either chemically and/or physically, to both of these components. By way of a non-limiting example, the tie layers 14, 26, respectively, can be sprayed (e.g., robotically) or otherwise applied on the entire surface of sub-layers 12b, 28b, respectively. The tie layer is then cured using UV radiation. With respect to the curing process, using FUSION F600S 600W lamps, the lights were unfocused at a distance of approximately 6 inches from the sheet. The conveyor moved the sheet under the lights at 10 to 20 feet per minute.

The adhesive layers, 16, 24, respectively, can then be applied to the cured tie layers, 14, 26, respectively. In accordance with one aspect of the present invention, the adhesives are comprised of UV-curable materials. The adhesive layers can be discontinuous, e.g., applied in droplet form, line form, grid form, serpentine form, and/or the like. Optionally, both the tie layers 14, 26, respectively, and the adhesive layers 16, 24, respectively, can be applied sequentially, and then cured simultaneously, e.g., after the respective reinforcement structures 18, 22, respectively, have been applied to the uncured adhesive layers 16, 24, respectively. When cured sequentially, the UV dosage and intensity is maximized during the first pass because of the absence of the fiberglass on the surface. The fiberglass reflects/absorbs a significant percentage of the UV light. The UV dosage and intensity values drop 80% from around 3.5 J/cm² @0.8 W/cm² to 0.80 J/cm² @0.125 W/cm².

In accordance with one aspect of the present invention, a suitable UV-curable adhesive is sold under the trade name LITE-LOC 491 readily commercially available from Permabond Engineering Adhesives, LLC (Somerset, N.J.). The product is a phenoxyethyl acrylate blend with acrylic acid. The adhesive has a photo-initiator that is active in the UV-V spectrum. This adhesive was specially formulated to be extremely viscous at 20,000 Cps at room temperature, so as to prevent running of the adhesive after it has been disposed on the tie layers 14, 26, respectively. This adhesive maintains adhesive properties up to about 190° F. The adhesive readily bonds to PC/ABS and fiberglass. Several other adhesive products were tested with limited success, e.g., failing at elevated temperatures, however, the addition of the acrylic acid monomer increased the toughness of the adhesive. Although this particular adhesive does not bond to the E3000 brand TPO, it does bond to the UV-curable tie layers of the present invention.

The adhesive of the present invention is intended to stitch bond the reinforcement structures 18, 22, respectively (e.g., fiberglass mats) to the inner surfaces of the TPO skin layers, i.e., sub-layers 12b, 28b, respectively. By way of a non-limiting example, small viscous droplets of the UV-curable adhesive can be sprayed onto the surface of the TPO, i.e., sub-layers 12b, 28b, respectively. The fiberglass mats are then vacuum-bagged down to the surface of the TPO and the UV-curable adhesive is activated through the bag and covering fiberglass mat. After removal of the bag, the fiberglass mat remains bonded to the surface through connection of the adhesive droplets. The injected foam later wets out the fiberglass mat and fills in the gaps between the adhesive droplets. Without being bound to a particular theory of the operation of the present invention, the bond of the foam to the TPO skin is stronger than the UV-curable adhesive to the TPO skin, especially at elevated temperatures, which permits the use of a minimized amount of adhesive and eliminates or at least reduces heat-induced skin delamination within an upper temperature limit of about 190° F.

In accordance with one aspect of the present invention, the reinforcement structures, 18, 22, respectively, can be comprised of materials such as but not limited to a fiberglass mat or mesh. As previously noted, the reinforcement structures, 18, 22, respectively, can be applied onto the uncured adhesive layers 16, 24, respectively. In accordance with an aspect of the present invention, the reinforcement structures 18, 22, respectively, contact the droplets of the adhesive layers 16, 24, respectively, or otherwise contact the adhesive material such that the reinforcement structures 18, 22, respectively, adhere to the adhesive layers, 16, 24, respectively. The adhesive layers, 16, 24, respectively, with the reinforcement structures 18, 22, respectively, in place are then cured using UV radiation, in this manner fixing the position of the reinforcement structures 18, 22, respectively.

The foam layer 20 can then be applied, e.g., via injection molding, in between two spaced and opposed reinforcement structures 18, 22, respectively. The foam layer 20 readily bonds to the tie layers, 14, 26, respectively, and any exposed reinforcement structures and thermoplastic skin layers. In accordance with one aspect of the present invention, the foam layer 20 can be comprised of polyurethane materials.

The polyurethane chemistry used in the present invention is polyisocyanurate-based. In accordance with one aspect of the present invention, the isocyanate index is around 150. The urethane chemistry has a physical blowing agent, e.g., HFC 245FA, otherwise known under the trade name ENOVATE 3000, which is readily commercially available from Honeywell Specialty Materials (Morristown, N.J.). The blowing agent is intended to reduce the viscosity of the resin and to assist wetting out the fiberglass reinforcing layers, i.e., reinforcement structures 18, 22, respectively. For example, the blowing agent also boils readily in the vacuum environment in the part, thus facilitating blowing of the foam. The blowing agent also creates internal pressure in the polyurethane cells which cause the surface cells to form a resinous skin layer that also aids in wetting out of the fiberglass mats. A significant advantage of this blowing agent is that when the pressure in the cavity exceeds 30 psi, the gaseous HFC 245FA brand changes back into a liquid that remains dissolved in the polyurethane. This significantly reduces the amount of voids present in the part. Conversely, polyurethanes blown with CO₂ blowing agents will not create this resinous layer and thus will have significantly higher void defect content.

A typical formulation of the foam component of the present invention is presented in Table II, set forth below:

TABLE II

| Component | Amount |
|---|---|
| Polyol A (e.g., rigid polyol) | 100 parts per hundred |
| | polyol (pphp) |
| Chain Extender (e.g., diethylene glycol) | 2-5 pphp |
| Catalyst A (e.g., blow gel catalyst) | 0.5-2 pphp |
| Catalyst B (e.g., trimerization catalyst) | 1-3 pphp |
| Water | 0-1 pphp |
| Silicone surfactant | 1-2 pphp |
| Blowing agent (e.g., HFC245FA) | 5-15 pphp |
| Isocyanate (e.g., polymeric MDI) | Quantity for an |
| | equivalent index of 1.5 |

With respect to the ingredients used in the foam layer 20, polyether polyols, rigid polyols and polymeric MDI blends are readily commercially available from Dow Chemical Corp. (Midland, Mich.), catalysts (e.g., blowing and gelling agents, trimerization agents, and/or the like) are readily commercially available from Air Products (Allentown, Pa.), surfactants are also readily commercially available from Air Products (Allentown, Pa.), HFC 245FA is also readily commercially available from Honeywell Specialty Materials (Morristown, N.J.), and cyclopentane, and blends of cyclopentane and isopentane, can also be used instead of HFC245FA, and are readily commercially available from Exxon Mobil (Irving, Tex.).

There are several advantages with the approach of the present invention, such as but not limited to: (1) improved weathering performance with co-extruded UV-stable TPO over conventional TPO; (2) delta E shifts around 1 compared to 5 with conventional PC/ASA skin layers; (3) improved resistance to solvents; (4) ability to control the gloss for the molded part; and (5) cost reductions with respect to material costs.

To determine the weathering characteristics of the composite sandwich structures of the present invention as compared to conventional composite sandwich structures, testing in accordance with the SAE J1960 specification was conducted. A weatherometer machine having an inner filter and an outer filter was used to simulate solar light conditions. The machine can employ a “Boro Boro” configuration (i.e., a borosilicate inner filter and borosilicate outer filter) and/or a “Boro Quartz” configuration (i.e., a borosilicate inner filter and a quartz outer filter). Using both Boro Boro filters and the Boro Quartz filters, the test took approximately 1895 hours and was equivalent to an exposure of 2,500 KJ, which equates to approximately 2 years of weathering. The ASA/PS substrates exhibited high color and gloss shifts, with delta E values between 4 and 6, wherein samples also exhibited cracking. Conversely, the E-3000 TPO samples of the present invention had delta E values between 1 and 2.

With respect to solvent resistance, conventional composite sandwich structures, such as those comprised of ABS, are very sensitive to solvents, such as acetone. Conversely, the TPO materials of the present invention are crystalline and are resistant to many solvents.

With respect to gloss variation, when conventional composite sandwich structures comprised of PC/ABS are extruded small streaks typically appear in the roll direction. When the sheets are heated for thermoforming, the streaks become more visible. Additionally, PC/ABS materials are very glossy and make defects very visible. Conversely, the TPO materials of the present invention do not gloss up when they are heated. The gloss level can be imprinted from the roll and the tool. Low gloss is easier to achieve than high gloss.

Gloss changes due to weathering are a different phenomenon. For example, when conventional PC/ABS oxidizes on the surface, this oxidation creates a barrier and protects the surface below. When the surface is cleaned, the surface oxide washes off and the gloss improves, but does not return to its original level. The TPO materials of the present invention do exhibit a gloss change, but the surface does not chalk as it is weathered. In some instances, the TPO materials get darker when weathered.

With respect to delamination characteristics, testing was performed using a simple temperature ramp and soak. The target maximum temperature for the panel was 190° F. The panel was ramped to this temperature over 4 hours then held at 190° F. temperature for 12 hours, then ramped down to room temperature in 4 hours. If the panel performs without delamination, there will be no visible blisters on the surface of the part. Also measured was the adhesion of the system by performing a peel test. 1″ wide×6″ strips were cut through the TPO skin and carefully lifted at one end. A force gauge was then used to measure the force needed to peel the TPO skin off the foam. Results achieved a maximum of 190N pull force.

With respect to the fabrication process, several different techniques were employed, as set forth in Examples I-III, set forth below:

### EXAMPLE I

This process involved spraying a very thin film of the UV-curable tie layer using an HVLP spray gun. The tie layer material was heated to 50° C. to reduce the viscosity. The film build was less than 1 mil. After spraying, the part was passed under a FUSION UV light system at a speed of 10 ft./min. and at a distance of 6 inches from the lights. After curing the UV tie layer, the adhesive was applied to the tie layer, creating a splatter coat of droplets over the surface thereof. This adhesive was used to knit the fiberglass to the tie layer. After spraying, the bi-directional knitted 20 oz/yd² fiberglass was positioned on the adhesive. A polyethylene vacuum bag was placed over the surface and the air was removed. Atmospheric pressure forced the fiberglass to the surface of the tie layer. The part was then passed through the UV light booth one more time to cure the UV adhesive. The part was now ready for the foaming stage.

### EXAMPLE II

The second process involved spraying the tie layer on the TPO skin followed immediately by spraying the adhesive, so essentially the process was “wet on wet.” After the adhesive was sprayed onto the tie layer, the fiberglass reinforcement and vacuum bagging steps were carried out. This process was intended to reduce the cycle time, although sufficient UV energy must be directed to both layers so as to ensure that the UV tie layer can be cured under the successive layers.

### EXAMPLE III

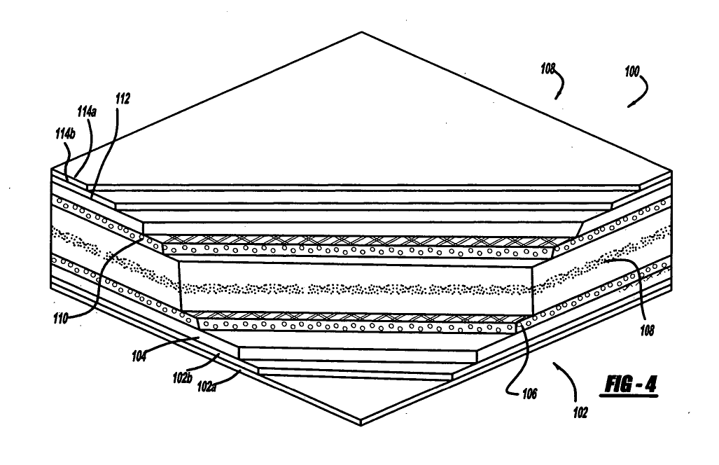

In the third process, the adhesive was eliminated altogether, whereas the build film of the UV-curable tie layer was increased, e.g., to 2-3 mil thickness, as shown in FIGS. 3 and 4. This particular embodiment, which is similar to the embodiment depicted in FIGS. 1 and 2, includes a composite sandwich structure, generally shown at 100. The structure 100 primarily includes a TPO skin layer 102, a tie layer 104, a reinforcement layer 106, an optional foam layer 108, another optional reinforcement layer 110, another optional tie layer 112, and another optional TPO skin layer 114. Again, as with the embodiment depicted in FIGS. 1 and 2, the TPO skin layers 102, 114, respectively, of this particular embodiment are actually comprised of two sub-layers 102a, 102b, 114a, 114b, respectively. The outermost layers, 102a, 114a, respectively, are comprised of TPO materials that include conventional UV stabilizers so as to provide enhanced weatherability to the structure 100, e.g., when it is exposed to UV sources. However, underlying sub-layers 102b, 114b, respectively, are comprised of TPO materials that do not contain any or any appreciable amounts of UV stabilizers, the reason for which will be explained herein. By way of a non-limiting example, the respective layers 102a, 102b and 114a, 114b, can be co-extruded together to form TPO skin layers 102, 114, respectively. After the build up of the tie layer was achieved, the fiberglass reinforcement and vacuum bagging steps were then carried out. This process was intended to be the fastest and most cost effective solution. One potential concern was poor adhesion of the fiberglass reinforcement. When the polyurethane foam was later injected into the cavity, the bond of the fiberglass needed to resist the stripping forces created by the injection pressure of the liquid resin, primarily in the gate areas.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A composite sandwich structure, comprising:
a thermoplastic layer having an inner surface and an outer surface;
wherein the inner surface does not include a UV stabilizer; and
a tie layer disposed on the inner surface of the thermoplastic layer.

2. The invention according to claim 1, wherein the tie layer is comprised of a UV-curable material.

3. The invention according to claim 1, further comprising a UV-curable adhesive layer disposed on the tie layer.

4. The invention according to claim 3, further comprising a reinforcement layer disposed on the UV-curable adhesive layer.

5. The invention according to claim 5, further comprising a foam layer disposed on the tie layer, UV-curable adhesive layer, or reinforcement layer.

6. The invention according to claim 5, further comprising:
a second thermoplastic layer having an inner surface and an outer surface;
wherein the inner surface does not include a UV stabilizer; and
a second UV-curable tie layer disposed on the inner surface of the second thermoplastic layer.

7. The invention according to claim 6, further comprising a second UV-curable adhesive layer disposed on the second UV-curable tie layer.

8. The invention according to claim 7, further comprising a second reinforcement layer disposed on the second UV-curable adhesive layer.

9. The invention according to claim 8, wherein the foam layer is disposed on the second UV-curable tie layer, second UV-curable adhesive layer, or second reinforcement layer.

10. A composite sandwich structure, comprising:
a first thermoplastic layer having an inner surface and an outer surface;
wherein the inner surface of the first thermoplastic layer does not include a UV stabilizer;
a first tie layer disposed on the inner surface of the first thermoplastic layer;
a second thermoplastic layer having an inner surface and an outer surface;
wherein the inner surface of the second thermoplastic layer does not include a UV stabilizer; and
a second tie layer disposed on the inner surface of the second thermoplastic layer.

11. The invention according to claim 10, wherein the first or second tie layers are comprised of a UV-curable material.

12. The invention according to claim 10, further comprising a UV-curable adhesive layer disposed on the first or second tie layers.

13. The invention according to claim 12, further comprising a reinforcement layer disposed on the UV-curable adhesive layer.

14. The invention according to claim 13, further comprising a foam layer disposed on the first and second UV-curable tie layers, UV-curable adhesive layer, or reinforcement layer.

15. The invention according to claim 14, further comprising a second UV-curable adhesive layer disposed on the second UV-curable tie layer.

16. The invention according to claim 15, further comprising a second reinforcement layer disposed on the second UV-curable adhesive layer.

17. The invention according to claim 16, wherein the foam layer is disposed on the second UV-curable tie layer, second UV-curable adhesive layer, or second reinforcement layer.

18. A method for forming a composite sandwich structure, comprising:
providing a thermoplastic layer having an inner surface and an outer surface;
wherein the inner surface does not include a UV stabilizer; and
disposing a UV-curable tie layer on the inner surface of the thermoplastic layer.

19. The invention according to claim 18, wherein the tie layer is cured after being disposed on the inner surface of the thermoplastic layer.

20. The invention according to claim 19, further comprising disposing a UV-curable adhesive layer disposed on the UV-curable tie layer, wherein the UV-curable adhesive layer is cured after being disposed on the UV-curable tie layer.
